(19) United States
(12) Patent Application Publication
(10) Pub. No.: US 2005/0068994 A1
(43) Pub. Date: Mar. 31, 2005

(54) Variable bandwidth signal multiplexer and demultiplexer

(76) Inventors: Nicholas F. DiCamillo, Torrance, CA (US); Garrick J. Harmon, Long Beach, CA (US); Keith W. Matthews, Cypress, CA (US); Terrence R. Smigla, Pacific Palisades, CA (US); Michael S. Munoz, Redondo Beach, CA (US)

Correspondence Address: POSZ & BETHARDS, PLC, 11250 ROGER BACON DRIVE, SUITE 10, RESTON, VA, 20190, US

(21) Appl. No.: 10/673,537

(22) Filed: Sep. 29, 2003

(51) Int. Cl. H04J 3/02

(52) U.S. Cl. 370/538

(57) ABSTRACT

A variable bandwidth signal multiplexer and demultiplexer. Aspects of the multiplexer may include a uniform bandwidth multiplexer with a composite signal output and a plurality of first bandwidth communication signal inputs. The first bandwidth signal inputs may be individually coupled to filters spanning a preselected bandwidth. A first external signal connection may couple to a first one of the first bandwidth communication signal inputs, while a first power divider may couple to a second external signal connection. The first power divider may include a first split output coupled to a second one of the first bandwidth communication signal inputs. The first power divider may also include a second split output coupled to a third one of the first bandwidth communication signal inputs. Aspects of the present invention also provide a demultiplexer that may generally correspond to various aspects of the multiplexer.

### BACKGROUND OF THE INVENTION

The present invention relates to communication systems. In particular, the present invention relates to a communication system that multiplexes signals of differing bandwidths into a composite signal and/or demultiplexes a composite signal into signals of differing bandwidths.

Recent years have seen dramatic improvements in communication system capacities, cost, and quality. In most communication systems, particularly wireless communication systems, transmitters send information in a channel using a signal that spans a predetermined fixed bandwidth. Frequently, the signals from multiple transmitters are combined into a wider-bandwidth transmission channel which is destined for a common gateway.

Such is commonly the case in satellite communications. In particular, a satellite may collect individual uplink signals (e.g., from a number of spot beams) and retransmit a composite downlink signal to a destination in a downlink. At the destination, a gateway typically extracts the individual signals from the downlink and forwards the individual signals to the appropriate destination.

In the past, a difficult problem has been making the most efficient use of the total available bandwidth on the combined transmission channel while using low-cost multiplexing and demultiplexing equipment. For example, when one or more transmitters are not using their assigned bandwidth it typically goes unused. As a result, bandwidth that could be used to generate revenue does not. In addition, where one or more transmitters needs to send more information than can be supported in its assigned bandwidth, the transmitter must take longer to send the information, or not sent it at all. Revenue may again be lost.

Limited attempts to address the problems noted above were made in the past. As an example, highly customized multiplexers and demultiplexers might be utilized to match the specific bandwidth needs of a collection of users. However, such equipment was typically expensive and only appropriate for a very specific network of transmitters. Given the need, generally, for less expensive and complex, yet more flexible communication systems, the past approaches were undesirable.

A need has long existed in the industry for a variable bandwidth signal multiplexer that addresses the problems noted above and others previously experienced.

### BRIEF SUMMARY OF THE INVENTION

A first method embodiment of the invention is useful for generating an output signal comprising a first bandwidth from a plurality input signals comprising bandwidths less than the first bandwidth. In such an environment, the first method embodiment comprises defining a filter function arranged to decrease signals outside a second bandwidth. The second bandwidth is less than the first bandwidth. The input signals comprising a third bandwidth that is a multiple of the second bandwidth are replicated to generate a number of replicated signals corresponding to the multiple. The replicated signals are filtered according to the filter function to generate filtered signals, and the output signal is generated in response to the filtered signals.

A first apparatus embodiment of the invention is useful for generating an output signal comprising a first bandwidth from a plurality input signals comprising bandwidths less than the first bandwidth. In such an environment, the first apparatus embodiment comprises a circuit responsive to the input signals comprising a third bandwidth that is a multiple of a second bandwidth less than the first bandwidth to generate a number of replicated signals corresponding to the multiple. A filter is arranged to filter the replicated signals by decreasing signals outside the second bandwidth in order to generate filtered signals, and an output is arranged to generate the output signal in response to the filtered signals.

A second method embodiment of the invention is useful for generating a plurality of output signals each comprising a first bandwidth in response to an input signal comprising a second bandwidth that is a multiple of the first bandwidth. In such an environment, the second method embodiment comprises defining a filter function arranged to decrease signals outside the first bandwidth. The input signal are replicated into a number of replicated signals corresponding to the multiple, and the replicated signals are filtered according to the filter function to generate the output signals.

A second apparatus embodiment of the invention is useful for generating a plurality of output signals each comprising a first bandwidth in response to an input signal comprising a second bandwidth that is a multiple of the first bandwidth. In such an environment, the second apparatus embodiment comprises a replicator arranged to replicate the input signal into a number of replicated signals corresponding to the multiple, and a filter arranged to filter the replicated signals to decrease signals outside the first bandwidth in order to generate the output signals.

By using the foregoing techniques, signals may be filtered and combined or power divided with a degree of ease and economy previously unattained.

### BRIEF DESCRIPTION OF THE DRAWINGS

FIG. 1 illustrates a communication system.

FIG. 2 shows a variable bandwidth signal multiplexer.

FIG. 3 shows a variable bandwidth signal demultiplexer.

FIG. 4 shows a high level flow diagram of a method for variable bandwidth signal return path multiplexing.

FIG. 5 shows a high level flow diagram of a method for variable bandwidth signal forward path demultiplexing.

### DETAILED DESCRIPTION OF THE INVENTION

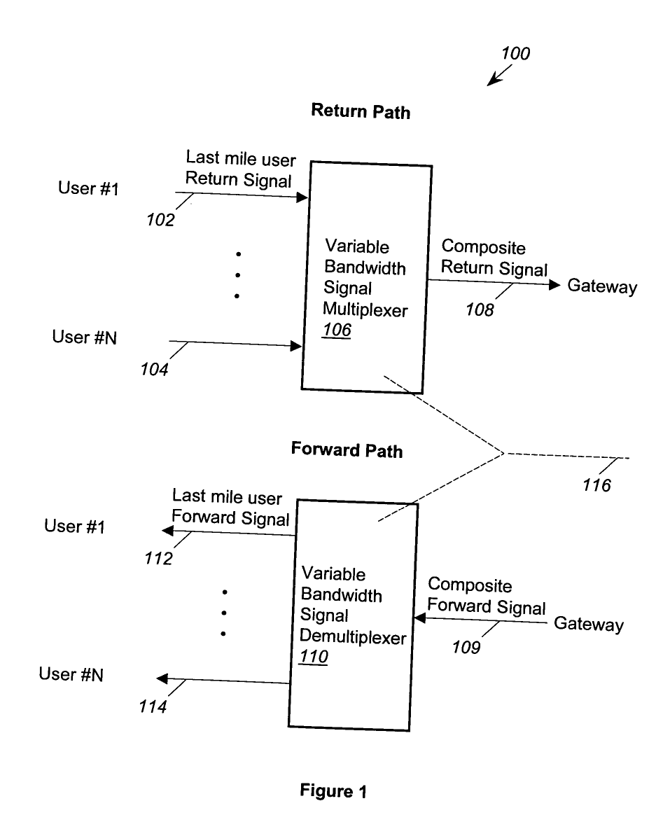

FIG. 1 illustrates a communication system 100 comprising a return path and a forward path. The return path includes last mile return signal inputs, two of which are identified as the communication signal input 102 and the communication signal input 104. The communication signal inputs are coupled to a variable bandwidth signal multiplexer 106. The output of the variable bandwidth signal multiplexer is a composite return output signal 108 that is transmitted to the common gateway.

In the forward path, the composite forward signal 109 from the gateway couples to a variable bandwidth signal demultiplexer 110. The variable bandwidth demultiplexer 110 provides several last-mile forward signal outputs, two of which are identified as the communication signal output 112 and the communication signal output 114. Additionally, an optional control channel 116 couples between the variable bandwidth signal multiplexer 106 and the variable bandwidth signal demultiplexer 110.

Either or both of the variable bandwidth signal multiplexer 106 and the variable bandwidth signal demultiplexer 110 may be terrestrially located or located in a satellite or spacecraft, as examples. The last mile and composite signal connections may then be a combination of one or more of wireless, hardwired, optical communication networks.

The communication signal input 102 carries, in some instances, a communication signal that is of different bandwidth than the signal present on the communication signal input 104. Thus, for example, the input 102 may carry a 100 MHz bandwidth signal, while the input 104 carries a 200 MHz or 300 MHz bandwidth signal. Similarly, the communication signal output 112 may carry a communication signal having a different bandwidth than the communication signal output 114. Thus, for example, the variable bandwidth signal demultiplexer 110 may provide several 200 MHz outputs and several 100 MHz outputs. The communication signal inputs and outputs are not restricted to any particular bandwidths, however.

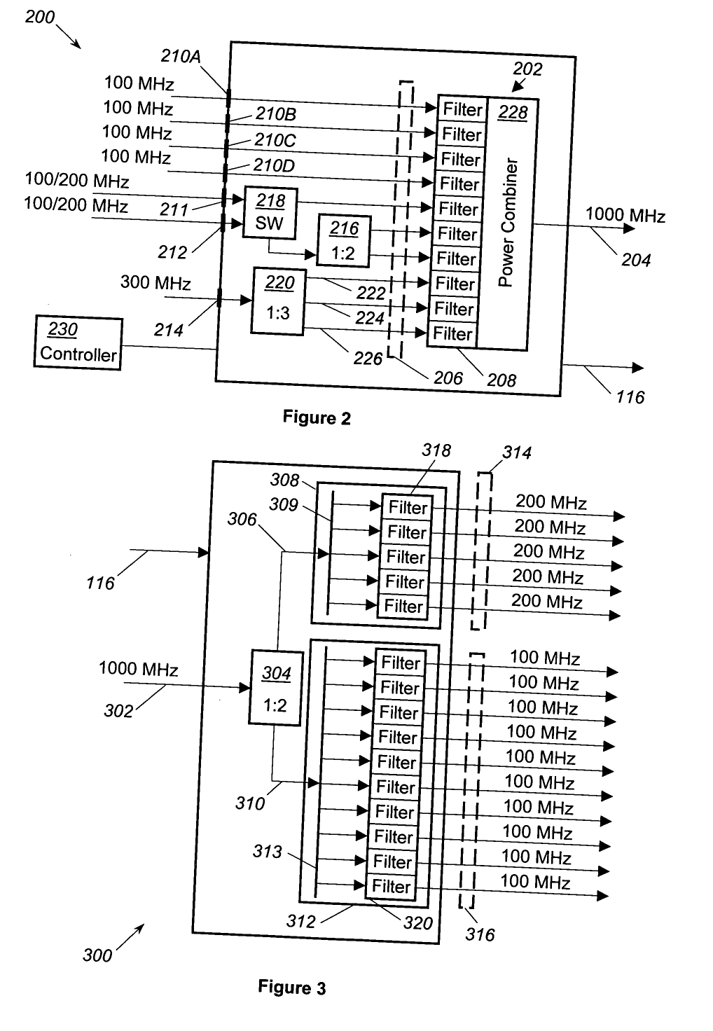

FIG. 2 illustrates in more detail a variable bandwidth signal multiplexer 200. The variable bandwidth signal multiplexer 200 includes a uniform bandwidth signal multiplexer 202 (including the filters and power combiner noted below), a composite signal output 204, and several first bandwidth (e.g., 100 MHz bandwidth) communication signal inputs 206. Each of the communication signal inputs 206 is individually coupled to a filter (e.g., the filter 208) that spans a preselected bandwidth (e.g., a 100 MHz bandwidth).

In addition, the variable bandwidth signal multiplexer 200 provides external signal connections. Seven such external signal connections are labeled in FIG. 2: the 100 MHz bandwidth external connections 210A-210D, the variable bandwidth external connections 211-212, and the 300 MHz external connection 214. A 1:2 power divider 216, coupled to the input switch 218, and a 1:3 power divider 220 are also present.

The 1:3 power divider 220 provides a first split output 222, a second split output 224, and a third split output 226. Each split output 222-226 carries a replica of the input signal present on the external connection 214 and is individually coupled to a filter.

The input switch 218 (under direction of the general-purpose controller 230, for example) may switch variable bandwidth input signals to an appropriate destination. For example, a 200 MHz bandwidth input is switched to the 1:2 power divider 216, while a 100 MHz bandwidth input is switched directly through to a 100 MHz bandwidth filter. A power combiner 228 combines the output of the filters into a composite output signal presented on the composite signal output 204.

As an example, the composite output signal may span 1000 MHz in bandwidth and the uniform bandwidth signal multiplexer 202 may include ten 100 MHz bandwidth filters, spaced 100 MHz apart in center frequency. Note, however, that the variable bandwidth signal multiplexer 200 does not require that each input signal span a 100 MHz bandwidth. Rather, each input signal may vary in bandwidth.

Thus, for example, and as shown in FIG. 2, four 100 MHz bandwidth external input connections are routed directly to filters. In addition, there is a 300 MHz bandwidth external input connection 214 routed to the 1:3 power divider 220. The 1:3 power divider 220 replicates the 300 MHz wide input signal on the split outputs 222-226. Each signal on a split output 222-226, however, is filtered by a 100 MHz bandwidth filter offset in center frequency such that the complete spectral content of the 300 MHz wide input signal is merged into the composite signal output in units of 100 MHz.

Assume a 100 MHz bandwidth input signal present at the first variable bandwidth external connection 211, and a 200 MHz bandwidth input signal present at the second variable bandwidth external connection 212. The input switch 218 directs the 100 MHz bandwidth input signal directly to a 100 MHz bandwidth filter and directs the 200 MHz bandwidth input signal to the 1:2 power divider 216. The split outputs of the 1:2 power divider 216 connect to 100 MHz bandwidth filters. As with the 300 MHz wide input signal, the complete spectral content of the 200 MHz signal is merged into the composite signal output. A composite 1000 MHz output signal is thereby formed using a uniform bandwidth multiplexer 202.

One example of the manner in which the bandwidths of the input signals may be arranged is as follows: the 100 MHz bandwidth signals coupled to inputs 210A-210D occupy the frequency range 0-400 MHz, respectively; the 100 MHz bandwidth signal coupled to input 211 occupies the 400-500 Mz range of frequencies; the 200 MHz bandwidth signal coupled to input 212 occupies the 500-700 MHz range of frequencies; and the 300 MHz bandwidth signal coupled to input 214 occupies the 700-1000 MHz range of frequencies. The signals on the output of divider 216 each occupy the 500-700 MHz range of frequencies. The signals on the output of divider 220 each occupy the 700-1000 MHz range of frequencies. In this example, the 10 filters 208 each serve as bandpass filters that decrease signals outside the following respective frequency ranges starting with the top filter: 0-100 MHz, 100-200 MHz, 200-300 MHz, 300-400 MHz, 400-500 MHz, 500-600 MHz, 600-700 MHz, 700-800 MHz, 800-900 MHz, and 900-1000 MHz. Each of the filters has a center frequency that is midway between the low and high frequency in its range. Thus, the center frequencies are separated by 100 MHz. For example, the top filter has a center frequency of 50 MHz, and the second filter from the top has a center frequency of 150 MHz. Thus, each signal coupled to a filter input includes the center frequency of that filter. The signal coupled to input 212 has a bandwidth that is an even multiple of two times the bandwidth of each of filters 208, the signal coupled to input 214 has a bandwidth that is an even multiple of three times the bandwidth of each of filters 208. The scope of the invention also includes input signals with bandwidths that are uneven multiples of the bandwidths of filters 208, e.g., a multiple of 1.2 or 1.8. Each of the filters acts as a noise filter that decrease signals outside its bandwidth. This filtering prevents noise on one of the input signals from interfering with noise on another of the input signals in the output signal.

The power dividers 216 and 220, and input switch 218 may be implemented as known to those skilled in the communication arts. The filters may be implemented as a software filter. In the case of a software filter, a filter algorithm defining a filter function is stored in controller 230 and is executed by controller 230. In the case of a software filter, the center frequency of the filter function changes to fit the frequency range of the input or replicated signal being filtered. The filters also may be implemented as a plurality of hardware filters, such as the filters shown in FIG. 2. Each of the filters shown in FIG. 2 defines a filter function. Additionally, the hardware filters may comprise a single hardware filter that defines a filter function. In this case, the input signals are stored in a buffer and are filtered serially after an appropriate frequency shift to match the frequency range of the hardware filter function.

The input switching and power dividing network (e.g., dividers 216 and 220 and switch 218) may be easily modified to create many different permutations of the non-uniform multiplexer.

Turning next to FIG. 3, that figure shows a variable bandwidth signal demultiplexer 300. The variable bandwidth demultiplexer 300 includes a control input 116, a composite signal input 302, and a 1:2 power splitter or power divider 304 coupled to the composite 1000 MHz bandwidth signal input 302. The 1:2 power splitter 304 provides a first split or replicated output 306 coupled to a first uniform bandwidth (200 MHz) demultiplexer 308, and a second split or replicated output 310 coupled to a second uniform (100 MHz) bandwidth demultiplexer 312. Demultiplexer 308 includes a 1:5 power divider 309, and demultiplexer 312 includes a 1:10 power divider 313.

The first uniform bandwidth demultiplexer 308 provides several first bandwidth (e.g., 200 MHz bandwidth) signal outputs 314. Similarly, the second uniform bandwidth demultiplexer 312 provides several second bandwidth (e.g., 100 MHz bandwidth) signal outputs 316. To that end, the first uniform bandwidth demultiplexer 308 incorporates 200 MHz bandwidth filters 318 (at differing center frequencies) and the second uniform bandwidth demultiplexer 312 incorporates 100 MHz bandwidth filters 320 (at differing center frequencies). For example, the filters in demultiplexer 308 serve as bandpass filters that decrease signals outside the following respective frequency ranges starting with the top filter: 0-200 MHz, 200400 MHz, 400-600 MHz, 600-800 MHz and 800-1000 MHz. Each of the filters has a center frequency that is midway between the low and high frequency in its range. Thus, the center frequencies are separated by 200 MHz. For example, the top filter has a center frequency of 100 MHz, and the second filter from the top has a center frequency of 300 MHz. Thus, each signal coupled to a filter input includes the center frequency of that filter. The input signal has a bandwidth that is an even multiple of the bandwidth of each of the filters in demultiplexers 308 and 312. The scope of the invention also includes input signals with bandwidths that are uneven multiples of the bandwidths of the filters, e.g., a multiple of 1.2 or 1.8. Each of the filters acts as a noise filter that decrease signals outside its bandwidth. This filtering prevents noise on the input signal from interfering with noise on one of the output signals.

The filters in demultiplexer 312 are constructed like the filters in FIG. 2.

Each of the signals input to the filters shown in FIG. 3 has a 1000 MHz bandwidth like the input signal on input 302. Each of the replicated signals on the outputs of divider 304 has a bandwidth of 1000 MHz.

In summary, the first uniform bandwidth demultiplexer 308 outputs five 200 MHz wide output signals and the second uniform bandwidth demultiplexer 312 outputs ten 100 MHz wide output signals. In the case illustrated in FIG. 3, where the composite input signal is 1000 MHz wide, not every signal output 314, 316 carries signal content representative of original input signals. For example, four 200 MHz signal outputs and two 100 MHz signal outputs may carry the spectral content of the 1000 MHz composite input signal produced by a variable bandwidth multiplexer with four 200 MHz input signals and two 100 MHz input signals.

As a result, the control input 116 may carry an active signal specifier to inform the variable bandwidth signal demultiplexer which outputs to produce or to switch off using internal switches, digital signal processors, programmable filters, and the like. The active signal specifier may be, for example, a multibit control word or the like. Furthermore, additional power splitters may be provided to route the composite input signals to additional uniform bandwidth signal demultiplexers adapted to additional bandwidths.

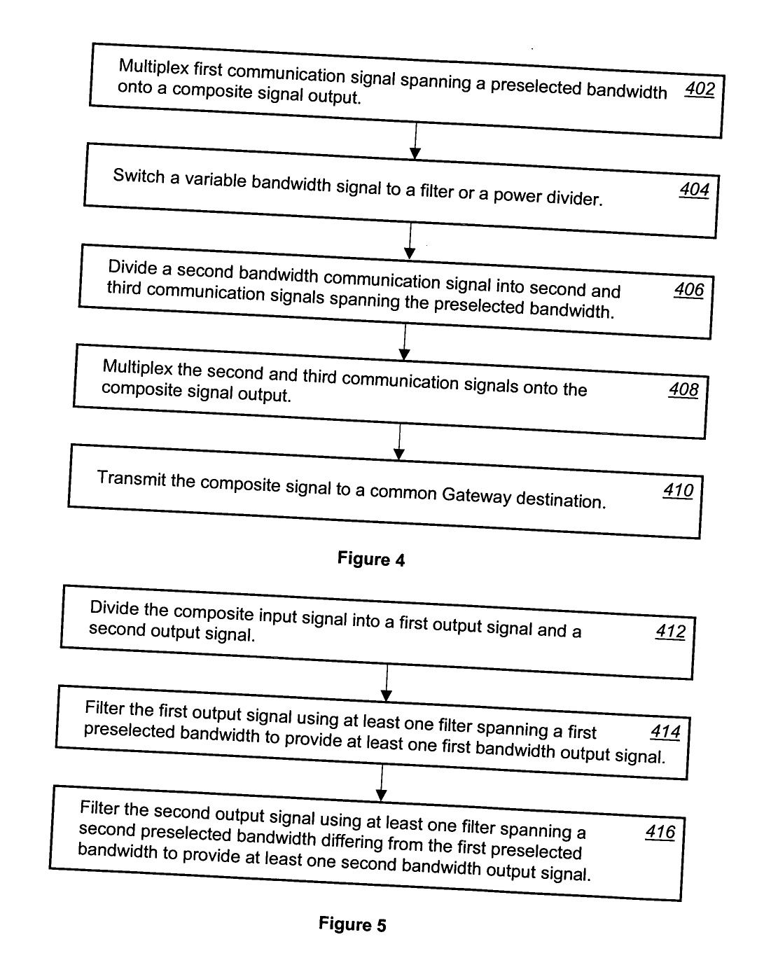

FIG. 4 illustrates a flow diagram of a method for variable bandwidth signal multiplexing in the return path. First, the communication system multiplexes (402) a first communication signal spanning a preselected bandwidth onto a composite signal output. Next, the communication system optionally switches (404) a variable bandwidth signal to a filter or a power divider. Subsequently, a second bandwidth communication signal is divided (406) into second and third communication signals spanning the preselected bandwidth. Finally, the communication system multiplexes (408) the second and third communication signals onto the composite signal output and transmits (410) the composite signal to a destination.

Referring to FIG. 5, at the receiver, in the forward path, the variable bandwidth demultiplexer divides (412) the composite input signal into a first output signal and a second output signal. Next, the first output signal is filtered (414) using at least one filter spanning a first preselected bandwidth to provide at least one first bandwidth output signal. Finally, the second output signal is filtered (416) using at least one filter spanning a second preselected bandwidth differing from the first preselected bandwidth to provide at least one second bandwidth output signal.

Thus, the invention provides a variable bandwidth signal multiplexer based on low-cost uniform bandwidth multiplexing building blocks. As a result communication signals of varying bandwidths may be accommodated without significant increases in cost or complexity in the communication system. The invention further provides a corresponding variable bandwidth signal demultiplexer, based on uniform bandwidth demultiplexing) for recovering the input signals.

While the invention has been described with reference to one or more preferred embodiments, those skilled in the art will understand that changes may be made and equivalents may be substituted without departing from the scope of the invention. In addition, many modifications may be made to adapt a particular step, structure, or material to the teachings of the invention without departing from its scope. Therefore, it is intended that the invention not be limited to the particular embodiment disclosed, but that the invention will include all embodiments falling within the scope of the appended claims.

1. A method of generating an output signal comprising a first bandwidth from a plurality of input signals comprising bandwidths less than the first bandwidth, said method comprising:
defining a filter function arranged to decrease signals outside a second bandwidth, the second bandwidth being less than the first bandwidth;
replicating the input signals comprising a third bandwidth that is a multiple of the second bandwidth to generate a number of replicated signals corresponding to the multiple;
filtering the replicated signals according to the filter function to generate filtered signals; and
generating the output signal in response to the filtered signals.

2. The method of claim 1 wherein the filter function defines a plurality of center frequencies including a predetermined center frequency applicable at the time the filter function filters one of the replicated signals and wherein the one replicated signal includes the predetermined center frequency.

3. The method of claim 2, wherein the plurality of center frequencies are separated by substantially equal frequencies.

4. The method of claim 1 wherein said defining the filter function comprises storing instructions for a software algorithm.

5. The method of claim 1 wherein said defining the filter function comprises providing a plurality of hardware filters.

6. The method of claim 1 wherein said input signals further comprise signals comprising the second bandwidth and wherein said filtering comprises filtering the signals comprising the second bandwidth according to the filter function to generate filtered signals.

7. The method of claim 1 wherein said replicating comprises power dividing.

8. The method of claim 1 wherein said filtering comprises noise filtering.

9. The method of claim 1 wherein said filtering comprises band pass filtering wherein the pass band comprises the second bandwidth.

10. The method of claim 1, wherein said generating comprises combining the filtered signals into the output signal.

11. The method of claim 1, wherein the first bandwidth comprises the sum of the bandwidths of the input signals.

12. Apparatus for generating an output signal comprising a first bandwidth from a plurality input signals comprising bandwidths less than the first bandwidth, said apparatus comprising:
a circuit responsive to the input signals comprising a third bandwidth that is a multiple of a second bandwidth less than the first bandwidth to generate a number of replicated signals corresponding to the multiple;
a filter arranged to filter the replicated signals by decreasing signals outside the second bandwidth in order to generate filtered signals; and
an output arranged to generate the output signal in response to the filtered signals.

13. The apparatus of claim 12 wherein the filter defines a plurality of center frequencies including a predetermined center frequency applicable at the time the filter filters one of the replicated signals and wherein the one replicated signal includes the predetermined center frequency.

14. The apparatus of claim 13, wherein the plurality of center frequencies are separated by substantially equal frequencies.

15. The apparatus of claim 12 wherein said input signals further comprise signals comprising the second bandwidth and wherein said filter is arranged to filter the signals comprising the second bandwidth to generate filtered signals.

16. The apparatus of claim 12 wherein said circuit comprises a power divider.

17. The apparatus of claim 12 wherein said filter comprises a noise filter.

18. The apparatus of claim 12 wherein said filter comprises a band pass filter wherein the pass band comprises the second bandwidth.

19. The apparatus of claim 12, wherein the first bandwidth comprises the sum of the bandwidths of the input signals.

20. A method of generating a plurality of output signals each comprising first bandwidth in response to an input signal comprising a second bandwidth that is a multiple of the first bandwidth, said method comprising:
defining a filter function arranged to decrease signals outside the first bandwidth;
replicating the input signal into a number of replicated signals corresponding to the multiple;
filtering the replicated signals according to the filter function to generate the output signals.

21. The method of claim 20 wherein the filter function defines a plurality of center frequencies including a predetermined center frequency applicable at the time the filter function filters one of the replicated signals and wherein the one replicated signal includes the predetermined center frequency.

22. The method of claim 21, wherein the plurality of center frequencies are separated by substantially equal frequencies.

23. The method of claim 20 wherein said replicating comprises power dividing.

24. The method of claim 20 wherein said filtering comprises noise filtering.

25. The method of claim 20 wherein said filtering comprises band pass filtering wherein the pass band comprises the first bandwidth.

26. The method of claim 20, wherein the second bandwidth comprises the sum of the first bandwidths of the output signals.

27. Apparatus for generating a plurality of output signals each comprising a first bandwidth in response to an input signal comprising a second bandwidth that is a multiple of the first bandwidth, said apparatus comprising:
a replicator arranged to replicate the input signal into a number of replicated signals corresponding to the multiple; and
a filter arranged to filter the replicated signals to decrease signals outside the first bandwidth in order to generate the output signals.

28. The apparatus method of claim 27 wherein the filter defines a plurality of center frequencies including a predetermined center frequency applicable at the time the filter filters one of the replicated signals and wherein the one replicated signal includes the predetermined center frequency.

29. The apparatus of claim 28, wherein the plurality of center frequencies are separated by substantially equal frequencies.

30. The apparatus of claim 27 wherein said replicator comprises a power divider.

31. The apparatus of claim 27 wherein said filter comprises a noise filter.

32. The apparatus of claim 27 wherein said filter comprises band pass filter wherein the pass band comprises the first bandwidth.

33. The apparatus of claim 27, wherein the second bandwidth comprises the sum of the first bandwidths of the output signals.
